(19) United States
(12) Patent Application Publication
(10) Pub. No.: US 2026/0243338 A1
(43) Pub. Date: Aug. 20, 2026

(54) INTEGRATED GEAR DIFFERENTIAL

(71) Applicant: Eaton Intelligent Power Limited, Dublin (IE)

(72) Inventors: Carlos H. Wink, Galesburg, MI (US); Nelson Roberto Brandao, Campinas, São Paulo (BR); John Allen Grogg, Marshall, MI (US); Daniel Philip Fisher, Marshall, MI (US)

(73) Assignee: Eaton Intelligent Power Limited, Dublin (IE)

(21) Appl. No.: 19/160,738

(22) PCT Filed: Mar. 1, 2024
(86) PCT No.: PCT/IB2024/052018

§ 371 Date: Aug. 28, 2025

Related U.S. Application Data
(60) Provisional application No. 63/487,712, filed on Mar. 1, 2023.

(51) Int. Cl. F16H 48/40; F16H 48/08; F16H 48/38; F16H 57/032

(52) U.S. Cl. CPC F16H 48/40; F16H 48/08; F16H 57/032; F16H 2048/385

(57) ABSTRACT

A differential arrangement for a vehicle includes a casing with a monolithically formed ring gear. A torque transfer arrangement is disposed within the casing. In certain cases, the casing is formed of two housing pieces. The ring gear is formed by one of the housing pieces. In certain cases, the torque transfer arrangement is substantially disposed within the other of the housing pieces. Eliminating a separate ring gear allows for a more robust casing without adding weight and/or cost. Further, forming the ring gear on the casing may reduce overall material usage without sacrificing strength.

### CROSS-REFERENCE TO RELATED APPLICATIONS

This application claims priority to U.S. Provisional Application Number 63/487,712, filed on Mar. 1, 2023, the disclosure of which is incorporated herein by reference in its entirety.

### BACKGROUND

A differential is a component of an axle assembly that is used to transfer torque from a driveshaft to a pair of output shafts. The driveshaft can drive the differential through the use of a bevel gear that meshes with a ring gear mounted to a housing of the differential. In automotive applications, a differential allows the tires mounted at either end of the axle assembly to rotate at different speeds. This is important when the vehicle is turning because the outer tire travels over an arc of greater distance than the inner tire. Thus, the outer tire must rotate at a faster speed than the inner tire to compensate for the greater distance of travel. The differential includes a gear arrangement that allows torque to be transferred from the driveshaft to the output shafts while concurrently allowing the output shafts to rotate at different speeds as needed.

To address increased fuel costs, the automotive industry has been driven to provide vehicles with increased fuel economy. To increase fuel economy, vehicle designers have looked for ways to remove weight from vehicles. Additionally, smaller vehicles have become more prevalent. In this environment, there is a need for differentials having reduced size and weight without loss of torque capacity when compared to conventional differential designs.

### SUMMARY

This disclosure pertains to a differential arrangement for use in a vehicle drive system. The vehicle drive system includes wheels, output shafts configured to drive the wheels, a drive shaft operationally coupled to the drive motor (e.g., electrical drive motor, combustion engine, etc.), and a drive gear rotated by the drive shaft. The vehicle drive system also includes a differential arrangement configured to transfer rotation of the drive gear to rotation of the output shafts while allowing the output shafts to rotate at different speeds.

In accordance with certain aspects of the disclosure, the differential arrangement includes a differential casing enclosing a torque transfer arrangement. The differential casing includes an integrated ring gear configured to mesh with the drive gear of the vehicle drive system to rotate the differential casing. In certain implementations, the ring gear is monolithically formed with at least part of the differential casing.

In certain implementations, the differential casing includes first and second housing pieces that cooperate to enclose the torque transfer arrangement. The ring gear is monolithically formed with the first housing piece.

In certain examples, the second housing pieces is formed of a different material from the first housing piece.

In certain examples, the first housing piece receives the first output shaft and the second hosing piece receives the second output shaft.

In certain examples, fasteners extend through radial portions of the first and second housing pieces, and wherein the ring gear extends axially over radial portions of the first and second housing pieces.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 shows an example traditional differential incorporate into a vehicle drive system;

FIG. 2 shows an example traditional differential housing and separate ring gear;

FIG. 3 is a perspective view of an example differential arrangement configured in accordance with the principles of the present disclosure;

FIG. 4 is an exploded view of the differential arrangement of FIG. 3 showing a first housing piece, a second housing piece, and a torque transfer assembly;

FIG. 5 is an axial cross-sectional view of the differential arrangement of FIG. 3;

FIG. 6 is a first perspective view of an example first housing piece of the differential arrangement of FIG. 3;

FIG. 7 is a second perspective view of the first housing piece of FIG. 6;

FIG. 8 is an axial cross-sectional view of the first housing piece of FIG. 6;

FIG. 9 is a first perspective view of an example second housing piece of the differential arrangement of FIG. 3; and

FIG. 10 is a second perspective view of the second housing piece of FIG. 9.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

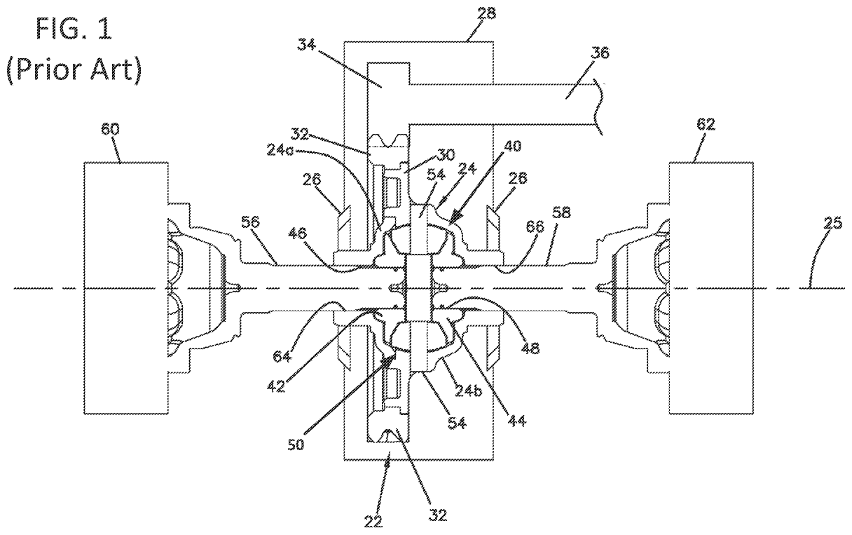

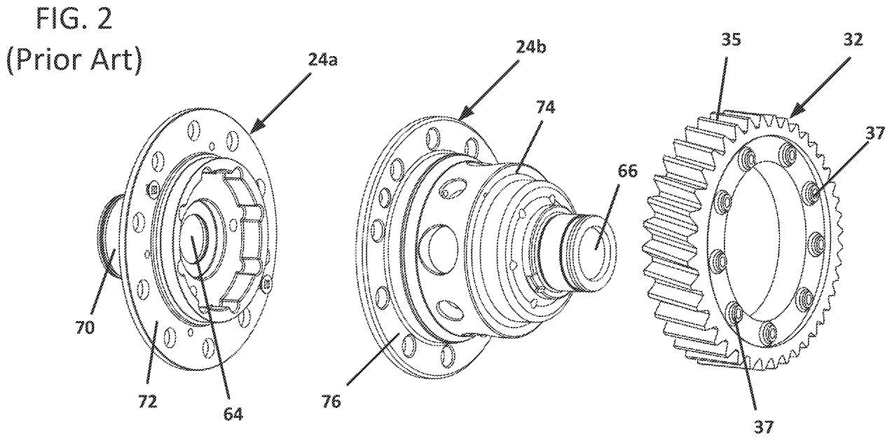

FIGS. 1 and 2 illustrates an example traditional differential 22 (e.g., a compact differential). The differential 22 includes a differential housing 24 that in use is rotated about a rotation axis 25. The differential housing 24 is rotatably mounted within an outer housing 28 (e.g., a differential carrier). The differential housing 24 includes a flange 30 for mounting a ring gear 32. In use of the differential 22, the ring gear 32 intermeshes with a drive gear 34 driven by a driveshaft 36. As the drive gear 34 is rotated by the driveshaft 36, the drive gear 34 engages the ring gear 32 thereby causing rotation of the differential housing 24 about the rotation axis 25.

First and second output shafts 56, 58 are coupled to the differential 22. The first and second output shafts 56, 58 are also shown coupled to respective first and second wheels 60, 62. The first and second output shafts 56, 58 extend outwardly from the differential housing 24 along the axis 25. The differential 22 includes a torque transfer arrangement 40 mounted within the housing 24. In certain implementations, the torque transfer arrangement 40 includes various gears that transfer torque from the differential housing 24 to the output shafts 56, 58.

In the depicted examples, the differential housing 24 includes a first housing piece 24a and a second housing piece 24b (e.g., see FIG. 2). The housing pieces 24a, 24b can be secured together by fasteners, welding or other techniques. Bearings 26 are provided at opposite ends of the differential housing 24 (e.g., see FIG. 1). The bearings 26 are co-axially aligned along the rotation axis 25 and are configured for rotatably mounting the differential housing 24 within an outer housing 28 (e.g., a differential carrier). Other differential housing configurations are possible (e.g., one housing piece, three housing pieces, etc.).

In the example depicted in FIG. 1, the torque transfer arrangement 40 includes first and second side bevel gears 42, 44 (e.g., sun gears) that respectively define first and second output shaft openings 46, 48 that are coaxially aligned along the rotation axis 25. The first output shaft 56 is rotatably received within a first output shaft opening 64 defined by the first housing piece 24a of the differential housing 24. The first output shaft 56 is also rotationally fixed within the first output shaft opening 46 of the first side bevel gear 42 by means such as splines or other torque transfer means. The second output shaft 58 is rotatably received within a second output shaft opening 66 defined by the second housing piece 24b. The second output shaft 58 is also rotationally fixed within the second output shaft opening 48 defined by the second side bevel gear 44 by means such as splines or other torque transfer means.

The torque transfer arrangement 40 also includes a gear set 50 (e.g., a planetary gear set) mounted between the first and second side bevel gears 42, 44. The gear set 50 is configured for transferring torque between the differential housing 24 and the first and second side bevel gears 42, 44 while concurrently permitting the first and second side bevel gears 42, 44 to rotate relative to one another (e.g., at different rotational speeds) about the rotation axis 25. The gear set 50 includes a densely packed array of pinion bevel gears. Each of the pinion bevel gears is rotatably mounted on a separate shaft 54 fixed relative to the differential housing 24. Each of the pinion bevel gears intermeshes with both the first side bevel gear 42 and the second side bevel gear 44. In other embodiments, multiple pinion bevel gears may be mounted on a common shaft secured to the differential housing 24. Other configurations of torque transfer assemblies are possible.

Further information about the example compact differential 22 is provided in U.S. Pat. No. 9,574,650, the disclosure of which is hereby incorporated herein by reference in its entirety.

FIG. 2 illustrates example implementations of a traditional differential housing 24 and ring gear 32. The differential housing 24 includes one or more housing pieces within which the gears of the torque transfer assembly 40 can be disposed. In the example shown, the differential housing 24 includes first and second housing pieces 24a, 24b that cooperate to enclose the torque transfer assembly 40. The ring gear 32 is separate from the differential housing 24. The ring gear 32 is mounted (e.g., bolted, welded, riveted, etc.) to an exterior of the differential housing 24 after the differential housing 24 is assembled. The ring gear 32 defines outwardly facing teeth 35 to mesh with the drive gear 34.

In some implementations, the ring gear 32 is formed of a different material from the differential housing 24. For example, the ring gear 32 can be formed of steel, cast iron, or powder metal to provide strength while the differential housing 24 is formed of aluminum of other such materials to mitigate weight. In other implementations, the differential housing 24 also could be formed of steel, cast iron, powder metal, or other such materials. In some implementations, the differential housing 24 and the ring gear 43 are manufactured and assembled at a common manufacturer. In other implementations, the differential housing 24 and the ring gear 32 are manufactured by different entities (e.g., different companies, different factories within the same company, different sub-companies, etc.) and assembled either by one of the entities or by a third entity.

Each of the housing pieces 24a, 24b includes an annular flange 72, 76 extending radially outwardly from a main body 70, 74, respectively. When assembled, the annular flanges 72, 76 are disposed together and bolts or other fasteners are inserted therethrough to hold the flanges 72, 76 together. The main bodies 70, 74 extend axially outwardly from the annular flanges 72, 76 to define passages through which the output shafts extend to reach the torque transfer assembly. At least one of the housing pieces 24a, 24b defines recesses and/or apertures that accommodate the torque transfer assembly. The ring gear 32 is slid over one of the main bodies 24a, 24b to axially abut one of the flanges 72, 76. In certain examples, bolts or other fasteners extend axially through the flanges 72, 76 and through channels 37 of the ring gear 32 to secure the ring gear 32 to the housing 24. In certain examples, the ring gear 32 extends over and partially covers apertures in the main body 70, 74 of one or both of the housing pieces 24a, 24b.

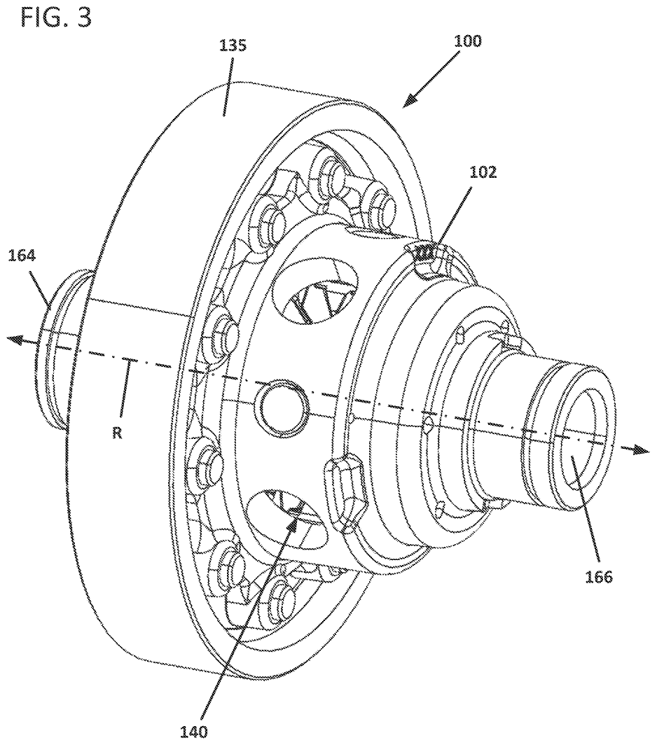

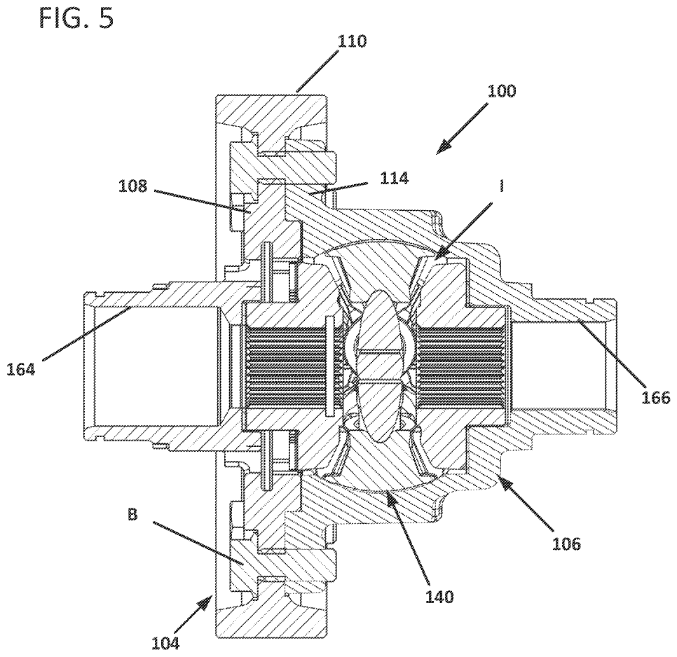

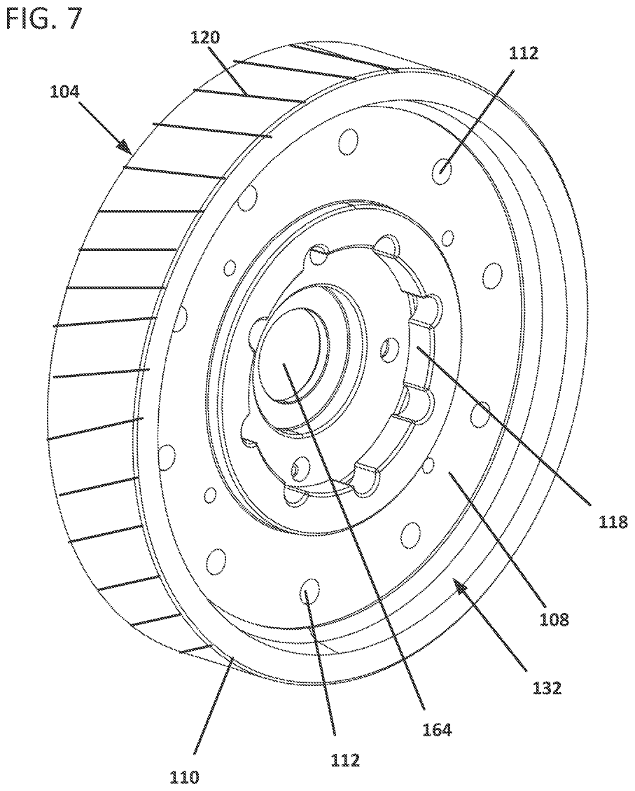

Referring now to FIGS. 3-10, a differential arrangement 100 includes a differential housing 102 configured to mesh directly with the drive gear of a vehicle (e.g., drive gear 34 of FIG. 1). The differential housing 102 includes a body that defines an interior I in which a torque transfer assembly 140 can be disposed (e.g., see FIG. 5). Various types of torque transfers are suitable for use within the differential housing 102. For example, torque transfers designed for open differentials, limited differentials, locking differentials, etc. can be disposed within the differential housing 102. The differential housing 102 defines first and second shaft openings 164, 166 aligned along a rotation axis R. The shaft openings 164, 166 are sized and configured to receive first and second output shafts (e.g., output shafts 56, 58 of FIG. 1) leading to respective wheels (e.g., wheels 60, 62).

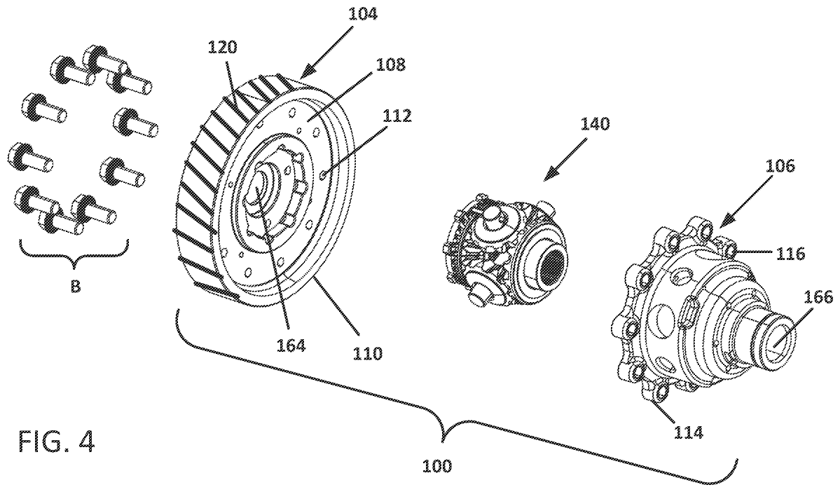

As shown in FIG. 4, the differential housing 102 includes a first housing piece 104 (e.g., a gear casing) and a second housing piece 106 (e.g., a main casing) that cooperate together to define the interior I. The first housing piece 104 defines the first shaft 164 and the second housing piece 106 defines the second shaft 166. The first housing 104 also defines a flange 108 extending radially outwardly from the first shaft 164 to an outer ring 110. The flange 108 defines a plurality of fastener openings 112. The second housing piece 106 includes a radial extension 114 defining a plurality of fastener openings 116. When the housing pieces 104, 106 are assembled together, the flange 108 of the first housing piece 104 abuts the radial extension 114 of the second housing piece 106 so that the fastener openings 112, 116 align (e.g., see FIG. 5). Bolts B or other fasteners (e.g., rivets) extend through the fastener openings 112, 116 to secure the housing pieces 104, 106 together. In certain examples, the fastener openings 112, 116 of either the flange 108 or the radial extension 114 are threaded or otherwise configured to interface with the bolts B. Which fastener openings 112, 116 are threaded depends on the intended direction of insertion of the bolts B. Because only two sets of openings 112, 116 need to align, insertion of the bolts B is facilitated in comparison to a traditional differential with separate gear ring 32. Alternatively, the flange 108 and radial extension 114 can be welded together.

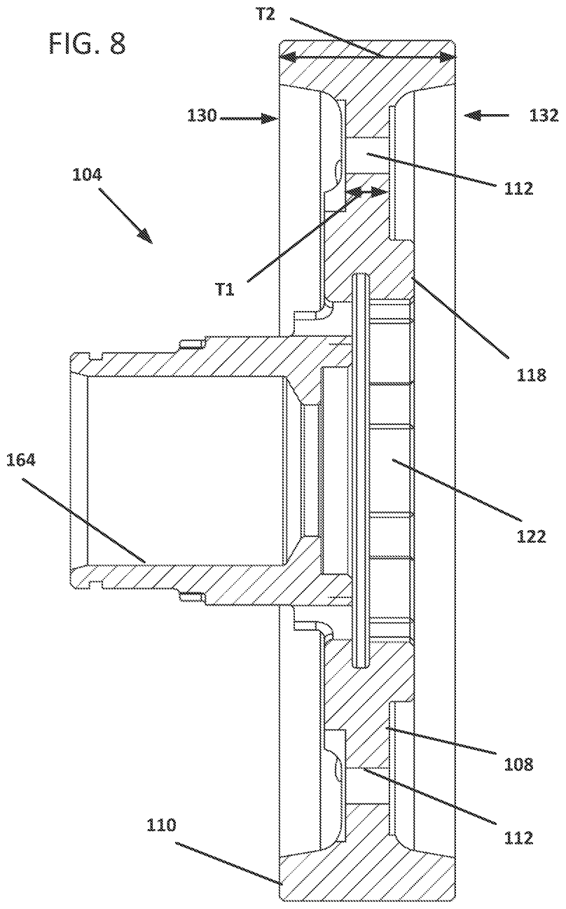

In certain implementations, the ring 110 includes a plurality of teeth 120 along an outer periphery of the ring 110 to form a gear. It is noted that the teeth 120 are shown schematically in the figures for convenience. In the depicted example, the gear is a helical gear having winding tooth lines. In other examples, however, the gear can be a spur gear or another type of gear. As shown in FIGS. 5 and 8, the ring 110 extends axially beyond opposite sides of the flange 108. Accordingly, the flange 108 is recessed inwardly from the end of the first housing piece 104. Further, the ring 110 extends axially over the flange 108 of the first housing piece 104 and over the radial extension 114 of the second housing 106. Each of the passages 164, 166 extends axially outwardly beyond the ring 110.

In accordance with certain aspects of the disclosure, the ring 110 is monolithically formed with the flange 108. In certain implementations, the ring 110, flange 108, and axial passage 164 are monolithically formed. In certain examples, the gear teeth 120 are monolithically formed with the ring 110. In some implementations, the first housing piece 104 is formed from a different material from the second housing piece 106. For example, the first housing piece 104 is formed from a robust material such as steel or cast iron while the second housing piece 106 is formed from a less robust, but lighter material such as aluminum. In other example, the first housing piece 104 is formed of steel and the second housing piece 106 is formed of cast iron. In other implementations, however, both of the housing pieces 104, 106 may be formed of the same material (e.g., steel or cast iron). In other implementations, the first housing piece 104 can be carburized while the second housing piece 106 is not.

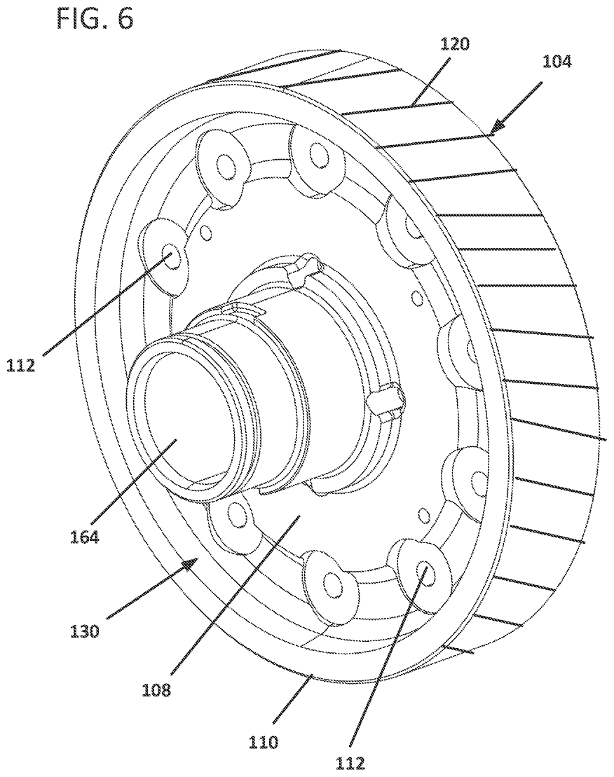

FIGS. 6-8 illustrate an example implementation of the first housing piece 104 suitable for use with the differential arrangement 100. The first housing piece 104 has opposite first and second major sides 130, 132. The first housing piece 104 includes a main body 118 from which the flange 108 extends radially outwardly. The main body 118 defines the first passage 164 that extends axially outwardly from the first side 130 of the first housing piece 104. The second side 132 of the first housing piece 104 is configured to face the second housing piece 106. The main body 118 defines a surface geometry 122 at the second side 132 configured to receive and engage portions of the transfer assembly 140. In the depicted example, the surface geometry 122 is recessed axially inwardly from the outer ring 110 of the first housing piece 104.

In certain implementations, the flange 108 has a thickness T1 extending between the first and second sides 130, 132 of the first housing piece 104. The fastener apertures 112 extend along the thickness T1. The ring 110 has an axial thickness T2 that extends between the first and second sides 130, 132. The axial thickness T2 of the ring 110 is at least twice as large as the axial thickness T2 of the flange 108. In certain implementations, the axial thickness T2 of the flange 108 of the first housing piece 104 is larger than the axial thickness of the flange 72 of the first housing 24a of a traditional differential arrangement (e.g., see FIGS. 1 and 2). The bolts B need not extend through a flange of a separate ring gear in addition to the flange 108 and radial extension 114. Accordingly, the flange 108 can be formed thicker and, hence, more robust in comparison to the flange of a traditional differential housing piece or the flange of a separate ring gear. Further, as can be seen in FIG. 8, the thickness T1 can vary as needed along the radial direction of the flange 108. For example, the thickness T1 can be shorter at the fastener openings 112 to help accommodate the bolts B and thicker closer to the main body 118 to provide extra strength.

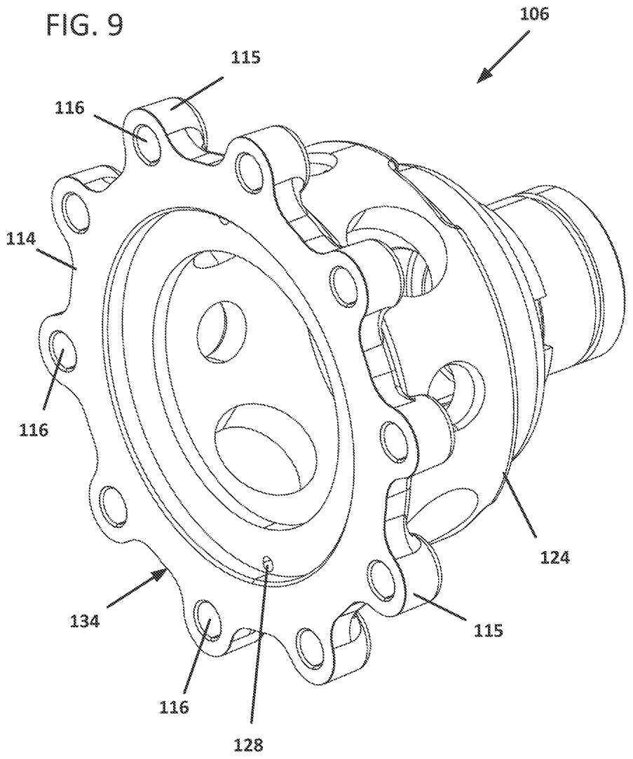

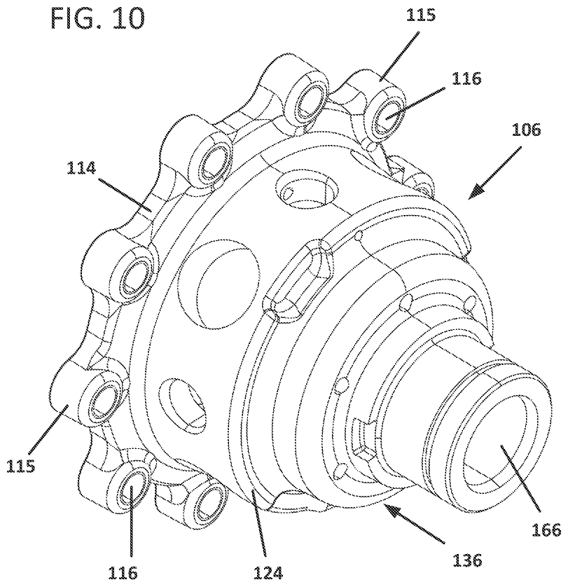

FIGS. 9 and 10 illustrate an example implementation of the second housing piece 106 suitable for use with the differential arrangement 100. The second housing piece 106 includes a main body 124 having opposite first and second major sides 134, 136. The first side 134 of the main body 124 faces the second side 132 of the first housing piece 104. The radial extension 114 is disposed at the first side 134 of the main body 124. The passage 166 extends axially outwardly from the second side 136 of the main body 124.

In certain implementations, the second housing piece 106 is the main casing of the differential 100. For example, in certain implementations, the main body 124 of the second housing piece 106 defines a majority of the interior I in which the transfer assembly 140 seats. In some examples, the torque transfer assembly 140 is fully seated within the main body 124 of the second hosing piece 106. In other examples, a portion of the torque transfer assembly 140 extends into the main body 118 of the first housing piece 104. In certain examples, the main body 124 defines one or more apertures to accommodate gears of the transfer assembly 140.

In some implementations, the radial extension 114 includes a radial flange having a constant diameter. In other implementations, the radial extension 114 includes a plurality of protrusions or bumps 115 that each define one of the fastener openings 116. In certain examples, the bumps 115 are equally spaced along the circumference of the extension 114. In certain examples, the bumps 115 result in less weight than a radial flange of constant diameter that defines fastener openings 116 in the same locations.

### Aspects of the Disclosure

Aspect 1. A differential arrangement of a vehicle drive system, the differential arrangement being operationally disposed between a drive gear driven by a drive shaft, a first output shaft to a first wheel, and a second output shaft to a second wheel, the vehicle differential system comprising:
a differential casing extending along an axis between opposite first and second ends, the differential casing defining a first axial passage extending to the first end and a second axial passage extending to the second end, the differential casing including:
a main casing defining the first axial passage leading to an interior of the main casing, the main casing including a radial extension extending radially outwardly from the interior;
a gear casing configured to mount to the main casing to enclose the interior of the main casing, the gear casing defining the second axial passage therethrough, the gear casing also including a radial flange extending outwardly from the second axial passage to an outer ring that defines external gear teeth, the outer ring and the gear teeth being monolithically formed with the radial flange.

Aspect 2. The differential arrangement of aspect 1, wherein the radial flange of the gear casing abuts the radial extension of the main casing when the gear casing is mounted to the main casing.

Aspect 3. The differential arrangement of aspect 2, wherein the radial flange and the radial extension each define fastener openings that align with each other when the gear casing is mounted to the main casing.

Aspect 4. The differential arrangement of aspect 3, further comprising a plurality of bots that extend through the fastener openings to secure the gear casing to the main casing.

Aspect 5. The differential arrangement of aspect 1, wherein the main casing extends along the axis between respective first and second axial ends, the radial extension being disposed at the first axial end; and wherein the gear casing extends along the axis between respective first and second axial ends, the radial flange being recessed axially inwardly from the second axial end.

Aspect 6. The differential arrangement of aspect 1, wherein the outer ring extends axially beyond the radial flange of the gear casing towards the first end of the differential casing.

Aspect 7. The differential arrangement of any of aspects 1-6, wherein the main casing is formed of a different material from the gear casing.

Aspect 8. The differential arrangement of aspect 7, wherein the main casing is formed of Aluminum and the gear casing is formed of steel.

Aspect 9. The differential arrangement of any of aspects 1-8, wherein the gear teeth of the outer ring form a helical gear.

Aspect 10. A differential arrangement of a vehicle drive system, the differential arrangement being operationally disposed between a drive gear driven by a drive shaft, a first output shaft to a first wheel, and a second output shaft to a second wheel, the vehicle differential system comprising:
a differential casing defining an interior, a first shaft passage leading to the interior from a first end of the differential casing, and a second shaft passage leading to the interior from a second end of the differential casing, the first shaft passage being configured to receive the first output shaft, and the second shaft passage being configured to receive the second output shaft;
a torque transfer arrangement disposed within the interior of the differential casing, the torque transfer arrangement including a plurality of gears configured to transfer a rotation of the differential casing to rotation of the first and second output shafts; and
a ring gear monolithically formed with the differential casing, the ring gear including gear teeth at an outer periphery of the ring gear, the gear teeth being configured to engage with the drive gear to rotate the differential casing.

Aspect 11. The vehicle differential system of claim 10, wherein the differential casing includes a first housing piece and a second housing piece, the ring gear being monolithically formed with the first housing piece, the second housing piece holding the torque transfer arrangement.

Aspect 12. The vehicle differential system of aspect 11, wherein the second housing piece is fastened to the first housing piece.

Aspect 13. The vehicle differential system of aspect 11 or aspect 12, wherein the first housing piece includes a radial flange, a conduit extending through a center of the radial flange, and an annular flange extending around a periphery of the radial flange, the annular flange forming the ring gear.

Aspect 14. The vehicle differential system of aspect 13, wherein the annular flange extends between opposite axial ends, and wherein the radial flange is recessed inwardly from both axial ends of the annular flange.

Aspect 15. The vehicle differential system of aspect 13, wherein the ring gear extends axially over the radial flange of the first housing piece and axially over a radial extension of the second housing piece.

Aspect 16. A differential arrangement of a vehicle drive system, the differential arrangement being operationally disposed between a drive gear driven by a drive shaft, a first output shaft to a first wheel, and a second output shaft to a second wheel, the vehicle differential system comprising:
a differential casing defining an interior, a first shaft passage leading to the interior from a first end of the differential casing, and a second shaft passage leading to the interior from a second end of the differential casing, the first shaft passage being configured to receive the first output shaft, and the second shaft passage being configured to receive the second output shaft, the differential casing including a ring gear monolithically formed with the first shaft passage, the ring gear including gear teeth at an outer periphery of the differential casing.

Aspect 17. The differential arrangement of aspect 16, wherein the second output shaft is formed of a different material than the first output shaft.

Aspect 18. The differential arrangement of aspect 17, wherein the second output shaft is formed of steel and the first output shaft is formed of cast iron.

Aspect 19. The differential arrangement of aspect 16, further comprising a torque transfer assembly disposed within the interior of the differential casing.

Aspect 20. The differential arrangement of any of aspects 16-19, wherein the differential casing includes a first housing piece and a second housing piece, the first housing piece being monolithically formed with the ring gear, the first housing piece defining the first shaft passage.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A differential arrangement of a vehicle drive system, the differential arrangement being operationally disposed between a drive gear driven by a drive shaft, a first output shaft to a first wheel, and a second output shaft to a second wheel, the vehicle differential system comprising:
a differential casing extending along an axis between opposite first and second ends, the differential casing defining a first axial passage extending to the first end and a second axial passage extending to the second end, the differential casing including:
a main casing having a first main body defining the first axial passage leading to an interior of the main casing, the main casing including a radial extension extending radially outwardly from the first main body;
a gear casing configured to mount to the main casing to enclose the interior of the main casing, the gear casing having a second main body defining the second axial passage therethrough, the gear casing also including a radial flange extending outwardly from the second main body to an outer ring that defines external gear teeth, the outer ring and the gear teeth being monolithically formed with the radial flange.

2. The differential arrangement of claim 1, wherein the radial flange of the gear casing abuts the radial extension of the main casing when the gear casing is mounted to the main casing.

3. The differential arrangement of claim 2, wherein the radial flange and the radial extension each define fastener openings that align with each other when the gear casing is mounted to the main casing, and wherein a plurality of bolts extend through the fastener openings to secure the gear casing to the main casing.

4. (canceled)

5. The differential arrangement of claim 1, wherein the main casing extends along the axis between respective first and second axial ends, the radial extension being disposed at the first axial end; and wherein the gear casing extends along the axis between respective first and second axial ends, the radial flange being recessed axially inwardly from the second axial end.

6. The differential arrangement of claim 1, wherein the outer ring extends axially beyond the radial flange of the gear casing towards the first end of the differential casing.

7. The differential arrangement of claim 1, wherein the main casing is formed of a different material from the gear casing.

8. The differential arrangement of claim 7, wherein the main casing is formed of cast iron and the gear casing is formed of steel.

9. The differential arrangement of claim 1, wherein the gear teeth of the outer ring form a helical gear.

10. A differential arrangement of a vehicle drive system, the differential arrangement being operationally disposed between a drive gear driven by a drive shaft, a first output shaft to a first wheel, and a second output shaft to a second wheel, the vehicle differential system comprising:
a differential casing defining an interior, a first shaft passage leading to the interior from a first end of the differential casing, and a second shaft passage leading to the interior from a second end of the differential casing, the first shaft passage being configured to receive the first output shaft, and the second shaft passage being configured to receive the second output shaft;
a torque transfer arrangement disposed within the interior of the differential casing, the torque transfer arrangement including a plurality of gears configured to transfer a rotation of the differential casing to rotation of the first and second output shafts; and
a ring gear monolithically formed with the differential casing, the ring gear including gear teeth at an outer periphery of the ring gear, the gear teeth being configured to engage with the drive gear to rotate the differential casing; and
a radial flange formed with the differential casing and extending to the ring gear, wherein the radial flange is recessed inwardly from axial ends of the ring gear.

11. The vehicle differential system of claim 10, wherein the differential casing includes a first housing piece and a second housing piece, the ring gear being monolithically formed with the first housing piece, the second housing piece holding the torque transfer arrangement.

12. The vehicle differential system of claim 11, wherein the second housing piece is fastened to the first housing piece.

13. The vehicle differential system of claim 11, wherein the first housing piece includes the radial flange, and an annular flange extending around a periphery of the radial flange, the annular flange forming the ring gear.

14. (canceled)

15. The vehicle differential system of claim 13, wherein the ring gear extends axially over the radial flange of the first housing piece and axially over a radial extension of the second housing piece.

16. A differential arrangement of a vehicle drive system, the differential arrangement being operationally disposed between a drive gear driven by a drive shaft, a first output shaft to a first wheel, and a second output shaft to a second wheel, the vehicle differential system comprising:
a differential casing defining an interior, a first shaft passage leading to the interior from a first end of the differential casing, and a second shaft passage leading to the interior from a second end of the differential casing, the first shaft passage being configured to receive the first output shaft, and the second shaft passage being configured to receive the second output shaft, the differential casing including a ring gear monolithically formed with the first shaft passage, the ring gear including gear teeth at an outer periphery of the differential casing; and
a torque transfer assembly disposed within the interior of the differential casing.

17. The differential arrangement of claim 16, wherein a main casing of the differential casing is formed of a different material than a gear casing including the ring gear of the differential casing.

18. The differential arrangement of claim 17, wherein the main casing is formed of steel and the gear casing is formed of cast iron.

19. (canceled)

20. The differential arrangement of claim 16, wherein the differential casing includes a first housing piece and a second housing piece, the first housing piece being monolithically formed with the ring gear, the first housing piece defining the first shaft passage.

21. The differential arrangement of claim 1, wherein the outer ring extends axially over first and second sides of the gear casing radial flange and axially over the main casing radial extension.

22. The differential arrangement of claim 1, further comprising a plurality of bolts securing the radial extension to the radial flange and wherein the outer ring extends axially over first and second sides of the radial flange and axially over the plurality of bolts on a side opposite the main casing.

23. The differential arrangement of claim 1, wherein the radial flange defines a first axial thickness and the outer ring defines a second axial thickness that is at least twice as large as the first axial thickness.
